(19) United States
(12) Patent Application Publication
(10) Pub. No.: US 2005/0229492 A1
(43) Pub. Date: Oct. 20, 2005

(54) Slotted extruded inverted carrier with improved pin ingress and egress

(75) Inventor: Jeffrey Charles Robertson, Rochester, NY (US)

Correspondence Address: BROWN & MICHAELS, PC;400 M & T BANK BUILDING, 118 NORTH TIOGA ST, ITHACA, NY, 14850, US

(73) Assignee: Caldwell Manufacturing Company, Rochester, NY (US)

(21) Appl. No.: 11/101,202

(22) Filed: Apr. 7, 2005

Related U.S. Application Data
(60) Provisional application No. 60/560,061, filed on Apr. 7, 2004.

(51) Int. Cl. E05D 15/22

(52) U.S. Cl. 49/181; 49/445

(57) ABSTRACT

This improved carrier allows for drop in type sash installation without having extended features which would preclude the use of wider sash and without having to position the two counterbalances at different vertical positions in order to insert a window sash's pivot bars into the carriers' cam slots. It is also adapted to receive multiple lock elements, wherein the lock elements can be sized to configure the carrier for use in different sized jamb pockets, eliminating the need for manufacturing tooling to produce the carrier component in a variety of sizes. In addition, it has features to retain the cam in its assembled position, independent of the lock, allowing the carrier and cam to be applied to a counterbalance prior to assigning the counterbalance to a particular jamb pocket size. When the particular application for the counterbalance is determined, the appropriate lock element can be readily applied, to properly size the counterbalance system to the application. Finally, this carrier includes retaining features allowing its use in conjunction with a pin having complementary features such that the pin cannot be pulled axially out of engagement with the cam once it is properly positioned therein.

### REFERENCE TO RELATED APPLICATIONS

This application claims an invention which was disclosed in Provisional Application No. 60/560,061, filed Apr. 7, 2004, entitled “Slotted Extruded Inverted Carrier with Improved Pin Ingress and Egress”. The benefit under 35 USC §119(e) of the United States provisional application is hereby claimed, and the aforementioned application is hereby incorporated herein by reference.

### FIELD OF THE INVENTION

The invention pertains to the field of tilt lock carriers. More particularly, the invention pertains to a tilt lock carrier for use with various types of counterbalances that has interchangeable locks to adapt the carrier to window systems with different size jamb pocket dimensions, and has features to reduce the difficulty normally associated with the installation and removal of a sash.

### BACKGROUND OF THE INVENTION

Many window sash counterbalance systems utilize a locking carrier to prevent the counterbalance from retracting when the sash is tilted out for cleaning, and when the sash is removed for maintenance or other reason. Typically, such locking carriers comprise a carrier body, cam and lock wherein the carrier body is attached to the counterbalance, the carrier body rotatably supports the cam, and slidably supports the lock in proximity to the cam. A pivot bar, attached at a bottom corner of a sash, and protruding laterally, is received in a slot or opening in the cam, such that tilting of the sash rotates the cam, which in turn slides or slidably expands the lock to a position wherein the lock bears outwardly against one or more surfaces forming the interior of the jamb pocket. Friction forces generated by the outwardly bearing lock are sufficient to prevent the counterbalance from moving the locking carrier, even if the weight of the sash is removed. In some embodiments, the outward portions of the lock element may be metallic and designed to imbed slightly into the surface of the jamb pocket wall to prevent carrier motion. Such carriers are commonly manufactured in multiple sizes to properly fit the many different jam pocket configurations prevalent in the window industry. Examples of such tilt lock carriers can be found in U.S. Pat. No. 6,032,417, issued to Jakus et al.; and in U.S. Pat. No. 4,610,108, issued to Marshick.

In many window systems, the jamb element adjacent the sash is formed from a plastic material, commonly extruded, and contains one or more pockets of an approximately rectangular cross section, which extend along the normal direction of travel of the window sash. Typically, a counterbalance and carrier are mounted within the pocket, with the pocket forming a guideway for the carrier as it travels. A slot shaped opening, in the side of the jamb pocket adjacent the sash, allows the protruding end of the pivot bar to penetrate the pocket, and engage the cam within the carrier.

When the counterbalance, or its attachment means to the carrier are such as to not obstruct the slot shaped opening of the jamb pocket immediately above the carrier, the carrier and cam can be designed to allow the pivot bar to drop vertically into the cam slot, thus enabling the sash to be easily installed and removed. (This style of carrier is illustrated in U.S. Pat. No. 5,301,467, issued to Schmidt et al., and in the carriers of FIGS. 6, 7, and 17 of U.S. Pat. No. 6,032,417). A further advantage of drop in designs is that they allow the use of pivot bars with interference features such as interference members or shapes (typically “T” or “L” shaped ends), that interfere with an element of the carrier to prevent axial withdrawal of the pin from the carrier. Thus, in the examples given, the overhanging portions of the “T” or “L” can engage at least one feature of the carrier, including its cam or lock, to “tie in” the pivot bar so that it does not slide axially out of engagement with the carrier, when, for instance an uninstalled window unit is lifted and carried by the center of one of its jambs.

To install a sash in this type of counterbalance system, the sash is first rotated slightly about a horizontal axis perpendicular to the plane of the window, such that the horizontal distance between the ends of the protruding pivot bars is less than the distance between the opposed faces of the jamb elements. The sash is then inserted into the opening between the jamb faces, and rotated back towards a horizontal position, such that the pivot bars now protrude into the slot shaped openings. The sash is then further rotated to the horizontal orientation and lowered, while in the horizontal orientation, so as to insert the pivot bars into their respective cam slots. Finally, the sash is tilted to its normally upright position, rotating the cams to positions where the lock elements are allowed to contract away from their extended, locked positions, freeing the carriers and counterbalances to support and guide the sash.

When the counterbalance, or its attachment means to the carrier obstruct the slot shaped opening, convenient drop in sash installation can still be provided, if the carrier and cam are extended toward the sash through the slot shaped opening in the jamb a distance sufficient to allow the extended portions of the carrier and cam to support the end of the pivot bar, while still allowing the pivot bar to drop past the counterbalance structure. While this carrier design does facilitate easy sash installation and removal, it requires a reduction in the size of the sash that could be fitted within a given window frame opening.

However, when the counterbalance system was such as to obstruct the slot shaped opening of the jamb pocket immediately above the carrier, and it was undesirable to reduce sash width to allow for a drop in carrier design, the window manufacturer and users of the window have been required to engage in an extremely difficult sash installation procedure comprising the following steps: 1) position the two counterbalances at different vertical positions, and operate the cams to lock the carriers in such positions, 2) rotate the sash slightly about a horizontal axis perpendicular the plane of the window, 3) insert the sash into the opening between the jambs, 4) insert one of the pivot bars into the opening of its respective cam, 5) overcome the locking force of the engaged carrier, and force that carrier upward or downward, until the unengaged pivot bar can be aligned with the opening of its respective cam, 6) force the first carrier to a position horizontally opposite the second, while guiding the second pivot bar into its respective cam opening, and 7) rotate the sash to its normally upright position, to unlock the carriers for normal sash operation. Illustrations of this type of carrier can be seen in U.S. Pat. No. 5,802,767, issued to Slocomb et al., and in the above referenced U.S. Pat. No. 4,610,108.

### SUMMARY OF THE INVENTION

An improved carrier has been developed for use with counterbalances wherein the counterbalance, or its means of attachment to the carrier, obstruct the slot shaped opening of the jamb pocket of the window in which the counterbalances are installed. This improved carrier allows for drop in type sash installation without having extended features which would preclude the use of wider sash and without having to position the two counterbalances at different vertical positions in order to insert a window sash's pivot bars into the carriers' cam slots.

A further advantage of this carrier is that it is adapted to receive multiple lock elements, wherein the lock elements can be sized to configure the carrier for use in different sized jamb pockets, eliminating the need for manufacturing tooling to produce the carrier component in a variety of sizes.

A still further advantage of this carrier is that it has features to retain the cam in its assembled position, independent of the lock, allowing the carrier and cam to be applied to a counterbalance prior to assigning the counterbalance to a particular jamb pocket size. When the particular application for the counterbalance is determined, the appropriate lock element can be readily applied, to properly size the counterbalance system to the application. This flexibility allows economy of inventory in situations where a window manufacturer may make a number of different model windows, perhaps featuring different jamb pocket sizes.

### BRIEF DESCRIPTION OF THE DRAWINGS

FIG. 1 shows a front perspective view of an improved carrier assembly produced in accordance with this invention, in an unlocked state, attached to a conventional inverted block and tackle counterbalance.

FIG. 2 is an enlarged front perspective view of the carrier assembly of FIG. 1, in a locked state.

FIG. 3 is an enlarged front perspective view of the improved carrier assembly, in an unlocked state, attached to a conventional inverted block and tackle counterbalance, with an alternate lock element, to adapt the carrier to a larger jamb pocket.

FIG. 4 is an enlarged front perspective view of the carrier assembly of FIG. 3, in a locked state.

FIG. 5 is a front perspective view of the improved carrier.

FIG. 6 is a rear perspective view of the improved carrier.

FIG. 7 is a front perspective view of the cam employed in the improved carrier assemblies of FIGS. 1-4.

FIG. 8 is a rear perspective view of the cam of FIG. 7.

FIG. 9 is a front perspective view of an improved carrier, with cam installed.

FIG. 10 is a cross-sectional view of the improved carrier and cam of FIG. 9 showing the cam retention snap.

FIG. 11 is a front perspective view of the lock element used in the improved carrier assemblies of FIGS. 1-2.

FIG. 12 is a front perspective view of the alternate lock element used in the improved carrier assemblies of FIGS. 3-4.

FIG. 13 is a perspective view of the improved carrier assembly of FIG. 4, installed in a jamb pocket, with a typical pivot bar in a position to be received in the carrier and cam.

FIG. 14 depicts the improved carrier assembly of FIG. 13, when the pivot bar has been received into the carrier and cam.

FIG. 15 shows the improved carrier assembly of FIG. 14, wherein the pivot bar has been rotated to a position consistent with the sash (not shown) having been tilted to it normal operating vertical orientation.

FIG. 16 is a top view of the improved carrier assembly of FIG. 4, illustrating the protrusion of the pivot bar beyond the outer face of the counterbalance structure, and illustrating the extension of the carrier face within the thickness of the return legs of the jamb extrusion.

FIG. 17 is a front perspective view of the improved carrier assembly of FIG. 2, showing the access slot top.

FIG. 18 is a cross-sectional view of the carrier assembly of FIG. 17, illustrating the arcuate path traveled by the end of the pivot bar during sash installation or removal.

### DESCRIPTION OF THE PREFERRED EMBODIMENT

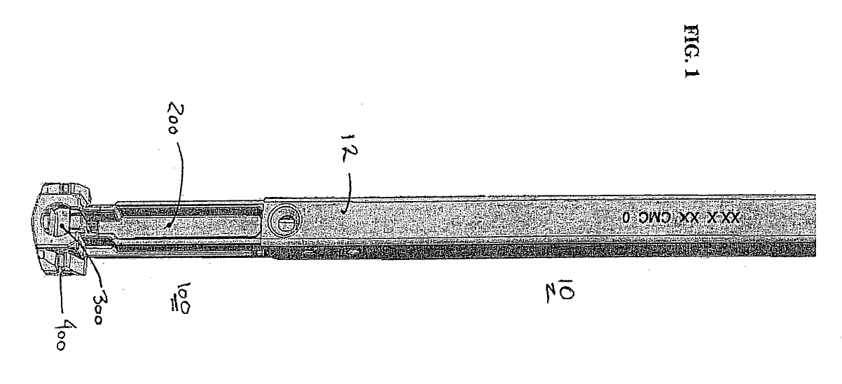

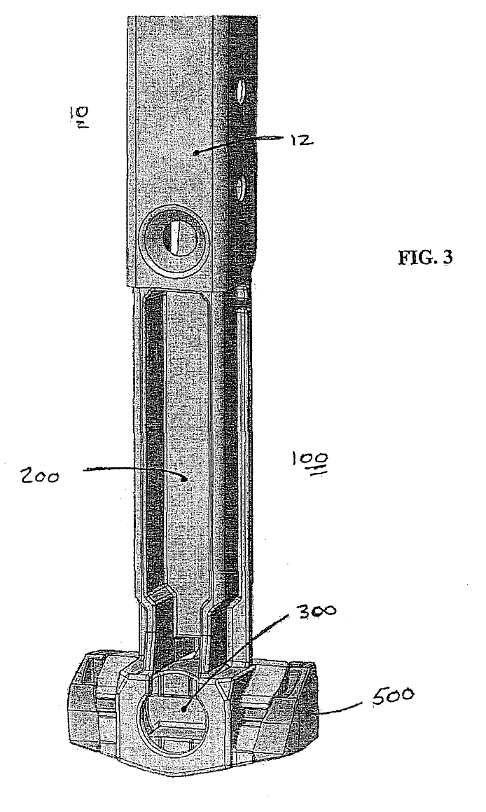

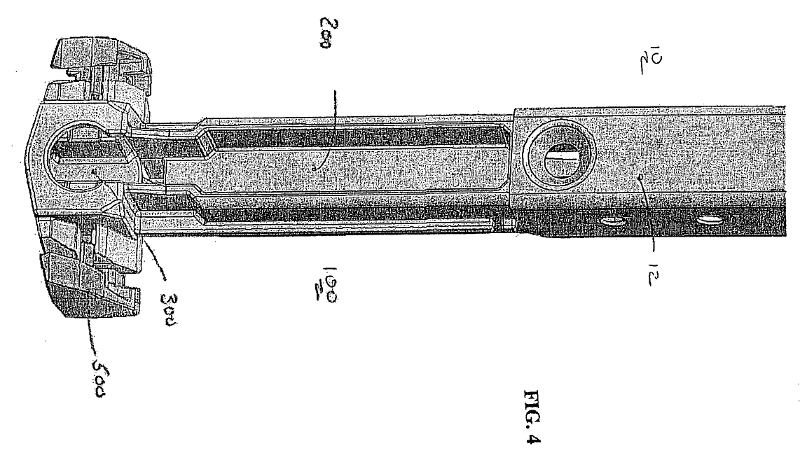

In FIGS. 1-4, a carrier assembly 100 is affixed to a counterbalance, represented in these illustrations as a block and tackle counterbalance 10, similar to that disclosed in U.S. Pat. No. 6,041,476, issued to deNormand, and more particularly, a block and tackle counterbalance 10, utilized in an inverted orientation, wherein the carrier assembly 100 is affixed to channel 12 of block and tackle counterbalance 10. Carrier assembly 100 may be affixed by any one of several methods, including riveting, screwing, or engagement of suitable interlocking features. Carrier assembly 100 comprises a carrier body 200, a cam 300, and a lock element 400, 500.

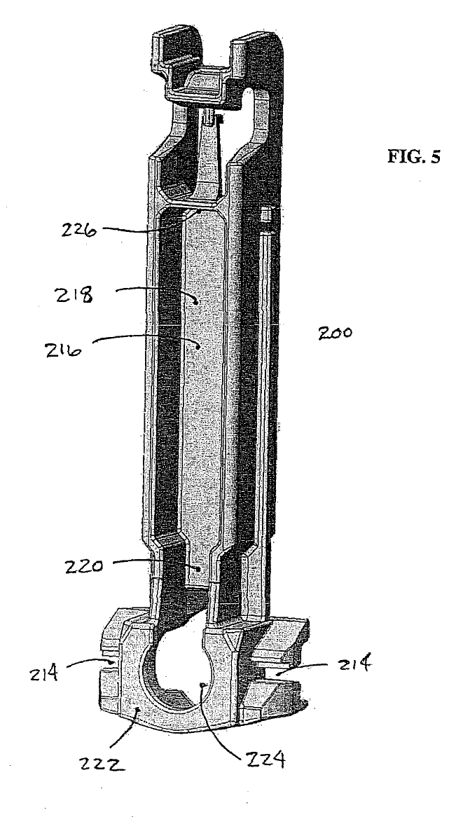

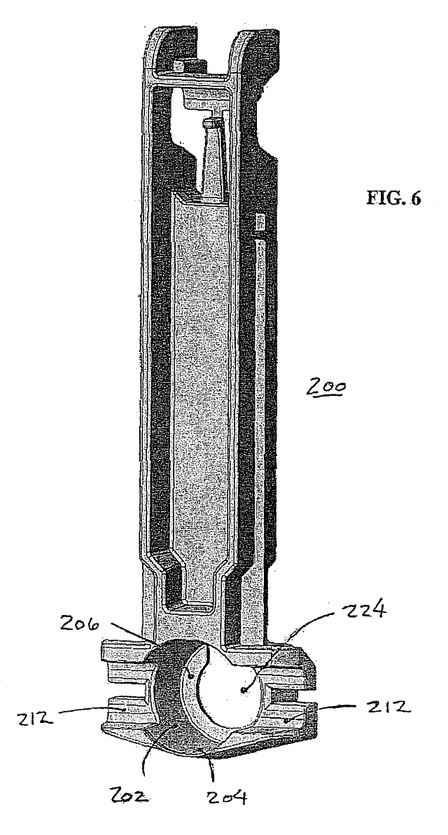

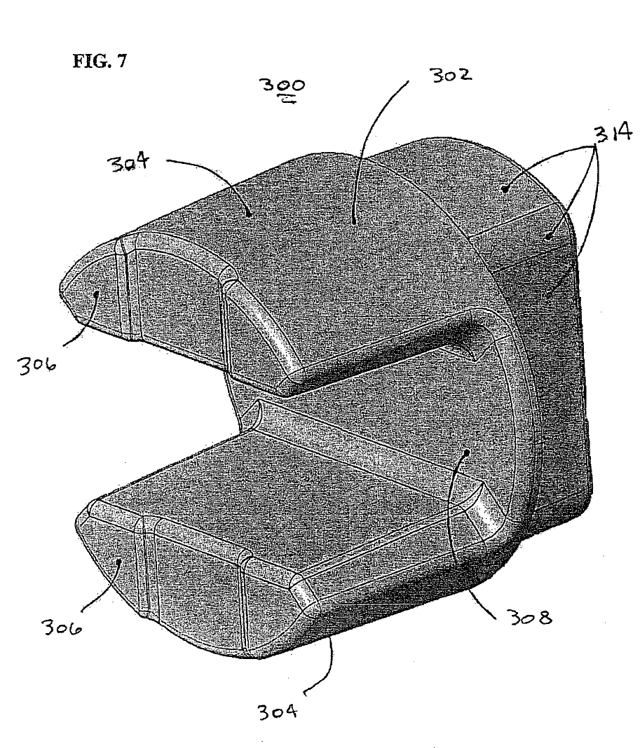

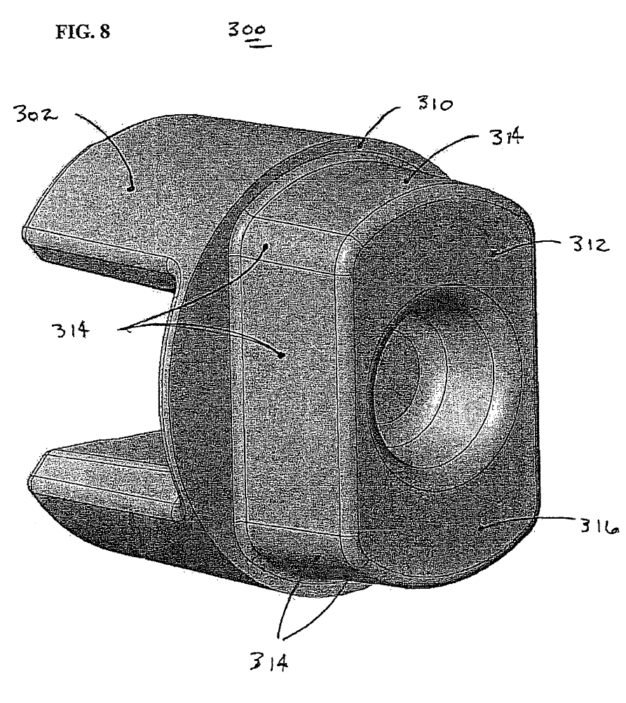

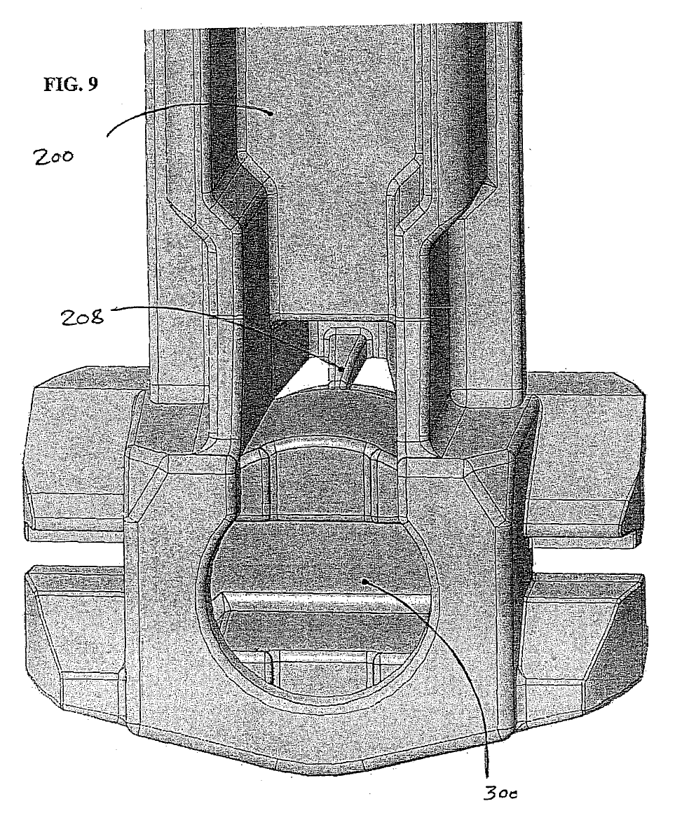

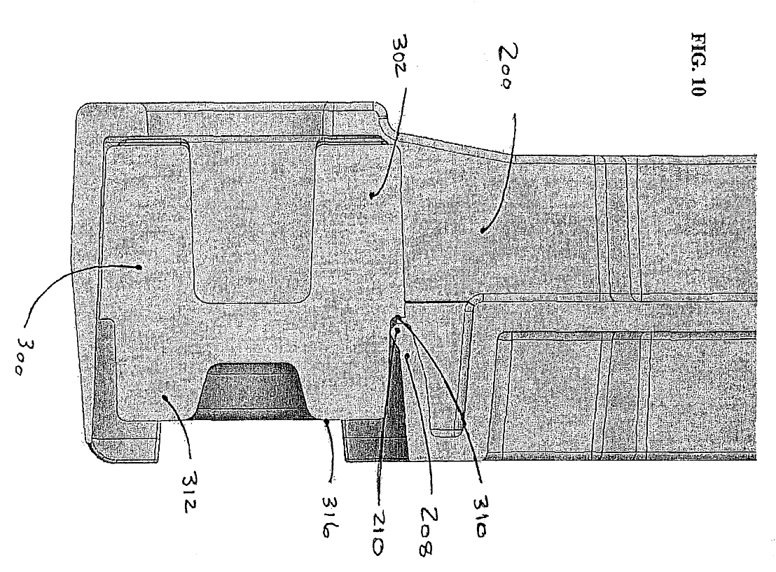

Referring to FIGS. 5-10, carrier body 200 has a cam pocket 202 defined by cam pocket wall 204 and cam pocket end 206, which receives the cylindrical front portion 302 of cam 300, with cylindrical surfaces 304 fitting concentrically within cam pocket wall 204, and front faces 306 abutting cam pocket end 206. Carrier body 200 has a cam snap 208 disposed alongside cam pocket 202, with at least cam snap tip 210 encroaching within cam pocket 202. When cam 300 is inserted into cam pocket 202 of carrier body 200, cam snap 206 resiliently deforms to allow the insertion of cam 300, returning to its undeformed state, when cam 300 is fully inserted, positioning cam snap tip 210 behind annular ledge 310 of cam 300, preventing cam 300 from being dislodged from cam pocket 202, while yet allowing cam 300 to rotate within the confines of cam pocket 202.

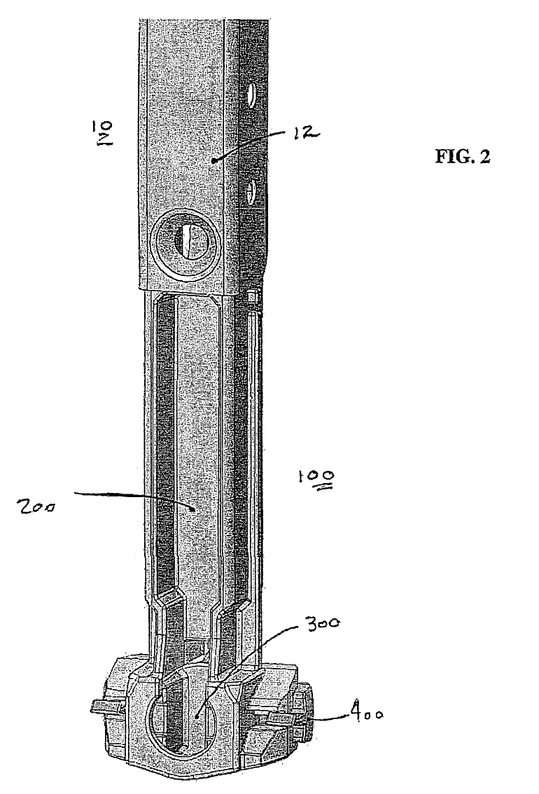

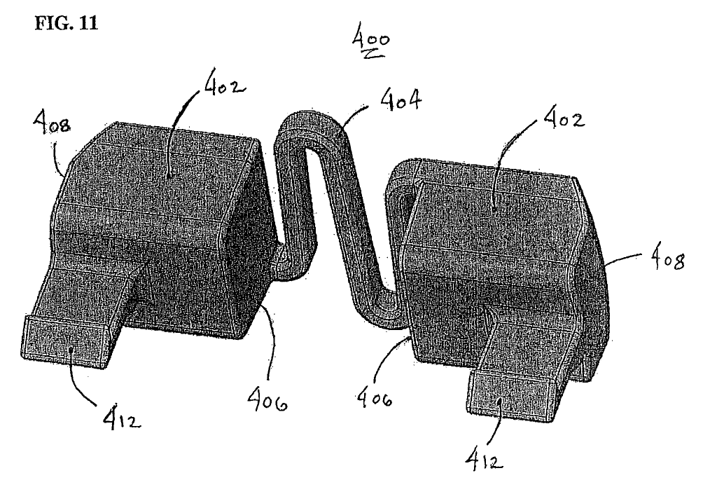

Carrier body 200 also has a transverse slot 212 to receive one of a lock element 400,500 shown in FIGS. 11,12. Lock elements 400, 500 are comprised each of two ear portions 402, 502, having opposed follower surfaces 406, 506, and interconnected by a serpentine spring section 404, 504. Ear portions 402, 502 of a lock element 400,500 are inserted into transverse slot 212 of carrier body 200, with lock snaps 412,512, extending through and engaging snap slots 214 of carrier body 200, and with ear portions 402, 502 sitting astride cam portion 312 of cam 300, and follower surfaces 406, 506 of the lock element 400,500 abutting cam surfaces 314 of cam 300. Ear portions 402, 502 and lock snaps 412, 512 are sized to fit respectively within transverse slot 212 and snap slots 214 with sufficient clearance to permit ear portions 402, 502, and lock snaps 412, 512 to slide laterally outward, as illustrated in FIGS. 2,4, when urged to do so by rotation of cam 300 *from a first position in which abutting cam surfaces 314 are spaced at a first distance to a second position wherein the abutting cam surfaces 314 are spaced at a second distance greater than the first distance?

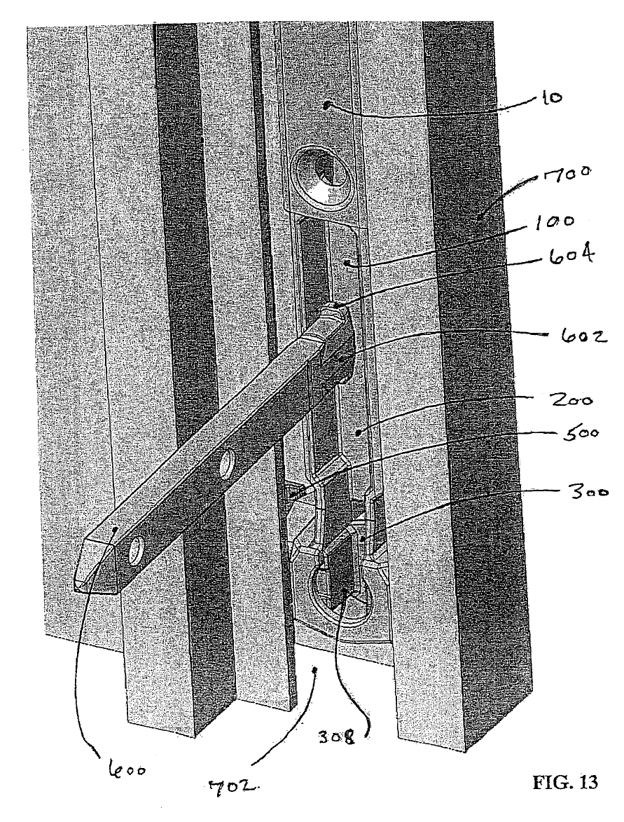

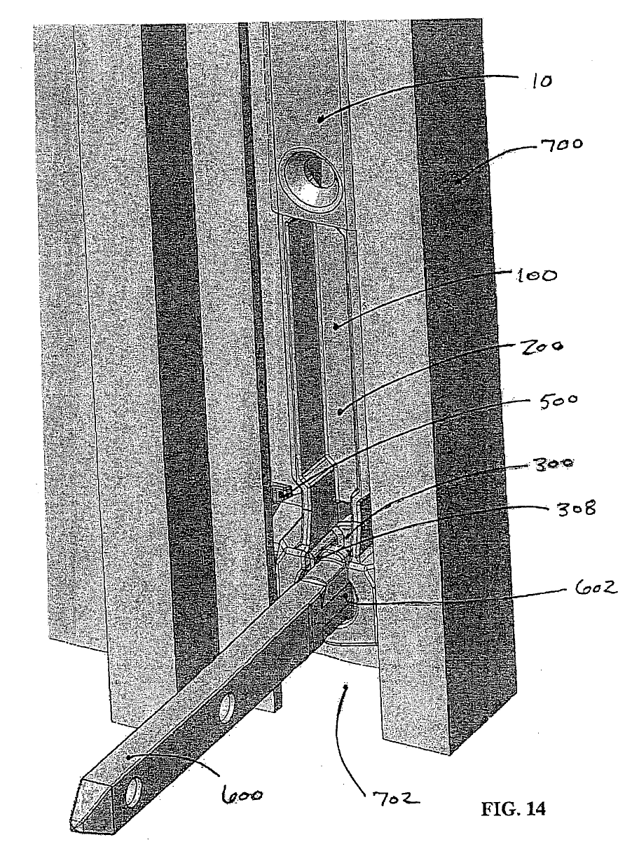

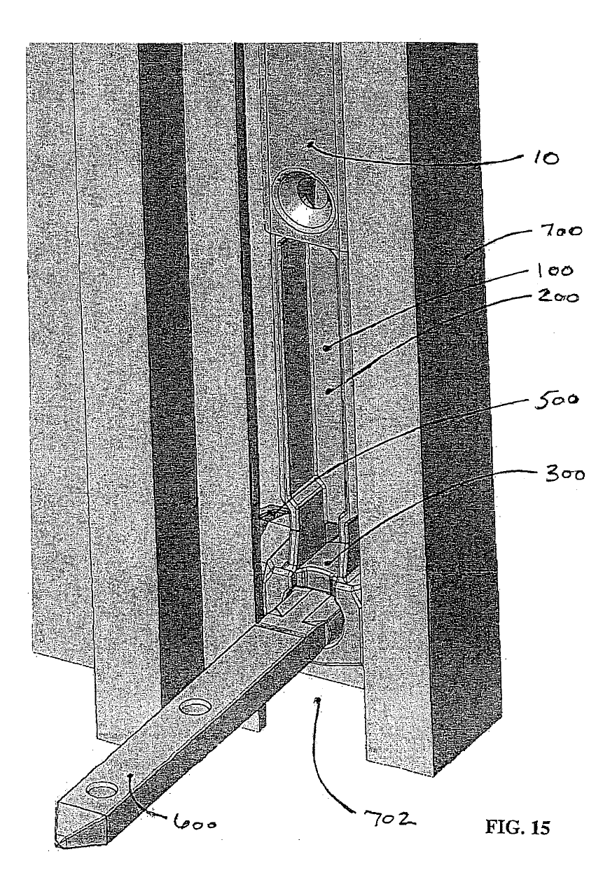

In FIGS. 13-16, a carrier assembly 100 affixed to a block and tackle counterbalance 10 is shown installed in a portion of a jamb extrusion 700 typical of those used in the construction of a double hung window. A jamb pocket 702 is bounded by back wall 704, side walls 706, and front walls 708, and extends the length of jamb extrusion 700. A pivot bar 600 attached to the lower corner of a double hung window sash (not shown for clarity) is received through slot 712 formed between the ends of return legs 710 of jamb extrusion 700, and within wider portion 218 of access slot 216 of carrier body 200, as illustrated in FIG. 13. In FIGS. 13, 14 cam 300 has been rotated to its second position, wherein cam slot 308 is aligned with narrower portion 220 of access slot 216. As pivot bar 600 (with attached sash, in a proper orientation for installation) is lowered, narrower portion 220 of access slot 216 guides the head 602 of pivot bar 600 into alignment with cam slot 308 of cam 300, allowing head 602 to easily and smoothly enter cam slot 308, achieving the position depicted in FIG. 14. In FIG. 15, pivot bar 600 has been rotated to a position corresponding to the tilted in, operating position of the sash, and cam 300, as a result of engagement with head 602 of pivot bar 600 within cam slot 308, has been rotated by pivot bar 600 to its first rotational position.

Pivot bar hole 224 in face 222 of carrier body 200 is sized to allow the rotation of pivot bar 600, while preventing wings 604 from moving axially through pivot bar hole 224, to provide the desired “tie in” behavior.

When cam 300 is rotated from its first position to its second position, sliding ear portions 402, 502 of lock elements 400, 500 laterally outward, brake surfaces 408,508 are forced against side walls 706 of jamb pocket 702, producing the necessary frictional forces to hold carrier assembly 100 and counterbalance 10 in position, when the sash is tilted out for cleaning, or removed for servicing. When the cam is rotated from its second position to its first position, serpentine springs 404, 504, retract the extended ear portions 402, 502, withdrawing brake surfaces 408, 508 from contacting side walls 706 of jamb pocket 702, freeing carrier assembly 100 and counterbalance 10 to move vertically within jamb pocket 702, to provide the desired guidance and support for the sash.

In the prior art, and in commercial practice there are many examples of carriers with lock elements wherein the lock element is manufactured in several configurations with slight differences in dimension to compensate for minor differences in jamb pocket dimensions which may occur between manufacturers, or where a different locking friction is desired. For major differences in jamb pocket dimensions, carrier manufacturers have provided carrier assemblies sized for the particular jamb pocket configuration, wherein the carrier bodies have also been sized to the jamb pocket size. Also in the prior art, and in commercial practice, carrier assemblies comprising a carrier body, a cam, and a lock element have been designed such that the cam is positively retained in the assembly by the presence of the lock element.

Carrier assembly 100 represents an improvement over prior art, in that it utilizes a single carrier body 200, and cam 300 in all applications. Only the lock element 400, 500 is specific to the particular jamb pocket size, thus, adapting carrier assembly 100 to a new and different jamb configuration can be accomplished by creating only a new lock element, similar to lock element 500, wherein lock extensions 510 are appropriately sized to fit the desired new jamb pocket dimensions. Further, when a particular window manufacturer may be making more than one model of window, perhaps with jamb extrusions having different sized jamb pockets, carrier bodies 200, with cams 300 installed can be affixed to appropriate counterbalances, and placed into inventory. Lock elements 400 and 500 can also be placed into inventory. As a window is constructed, a pair of counterbalances of the correct weight capacity for each sash can be withdrawn from inventory, along with a pair of the appropriate lock elements 400,500, dependent on the jamb pocket size present in the window under construction. The selected lock elements 400 or 500 can then be snapped in position, to complete the carrier assemblies 100, and the completed carrier assemblies 100 and counterbalances 10 can be installed in the jamb pockets of the window under construction. This inventory scheme will generally allow a smaller overall inventory than would be required if separate inventories of completed carrier and counterbalance assemblies were maintained with multiple sizes of carriers.

Carrier body 200 thus represents an improvement over prior art, in that it retains an installed cam 300 independently of the presence of a lock element 400,500, which enables a later assembly of lock element 400, 500.

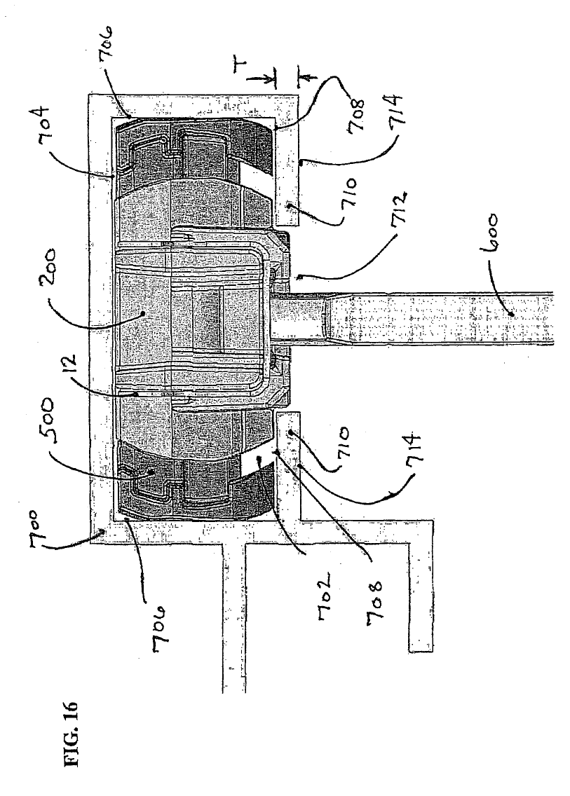

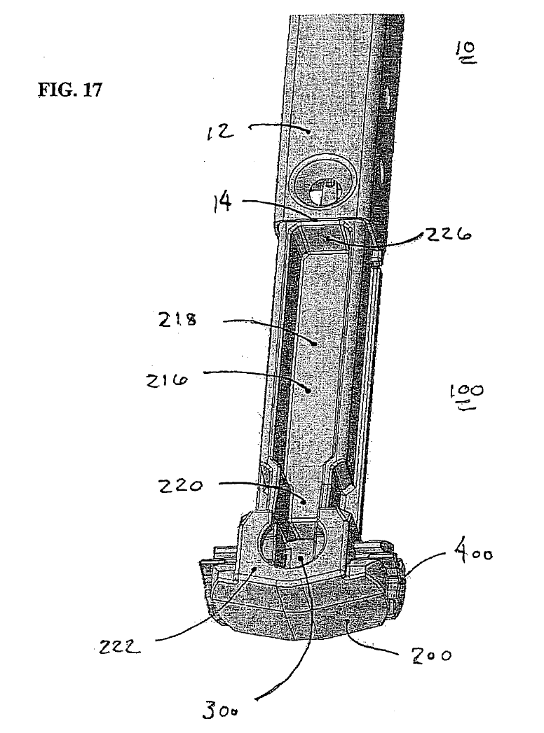

A seven step installation procedure for installing sash into a window equipped with a current art inverted block and tackle counterbalances with attached carriers was described above. A simplified method for the installation of a window sash into a window constructed with jamb extrusions 700, and equipped with improved carrier assemblies 100 will now be described, with reference to FIGS. 16-18, and features of carrier body 200, which enable this simplified method will be disclosed.

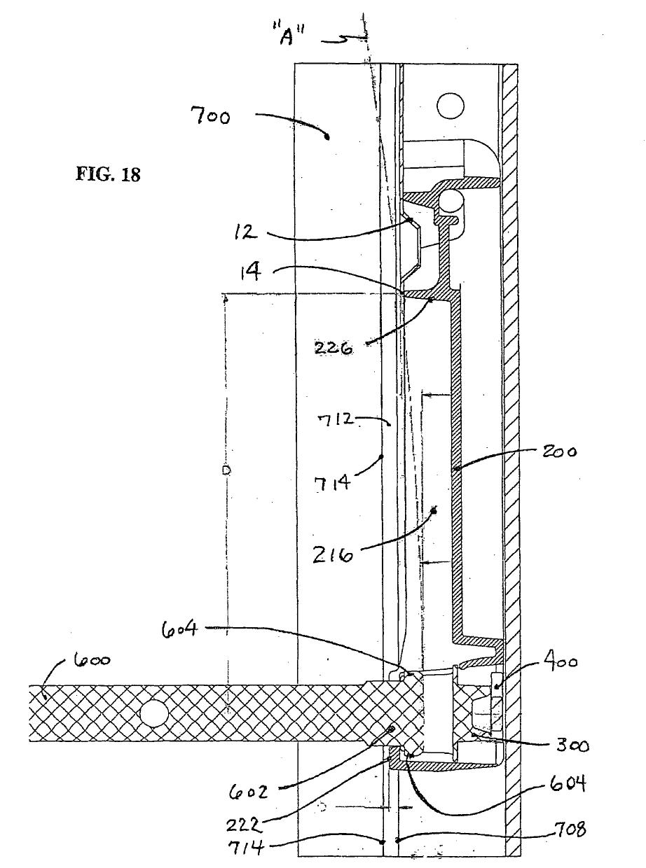

First and second carrier assemblies 100, affixed to first and second block and tackle counterbalances 10, are installed in opposing first and second jamb extrusions 700, positioned at an approximately equal elevation, and cams 300 are rotated to their respective second positions, with cam slots 308 aligned with access slots 216 of carrier bodies 200. A sash, with first and second pivot bars 600 affixed to the lower edge of the sash, and protruding beyond the sides of the sash, is rotated about a horizontal axis perpendicular to the plane of the window, such that the horizontal distance between the ends of the pivot bars is less than the horizontal distance between sash faces 714 of the opposing first and second jamb extrusions 700. The sash with protruding pivot bars 600 is then moved into the intervening space between sash faces 714 of opposing jamb extrusions 700. The sash is then moved laterally, toward the first carrier assembly 100, until the head 602 of first pivot bar 600 extends through slot 712 of the first jamb extrusion 700, and enters into access slot 216 of carrier body 200 of the first carrier assembly 100. The sash is then lowered, until the head 602 of the first pivot bar 600 is received into cam slot 308 of cam 300 of the first carrier assembly 100. Next, the sash is rotated about the head 602 of the first pivot bar 600, toward a horizontal position, causing head 602 of the second pivot bar 600 to move along the arcuate path “A” shown in FIG. 18. When head 602 of second pivot bar 600 has been received into cam slot 308 of cam 300 of the second carrier assembly 100, the sash is finally tilted to its closed normally operating position, causing rotation of pivot bars 600, and the attendant rotation of cams 300 to their respective first positions, wherein first and second carrier assemblies 100 are unlocked and free to move with and support the installed sash.

This procedure is advantaged over the more difficult seven step procedure in that there is one fewer steps, and the individual installing a sash is not required physically overpower the carrier locking system to move either balance as described in steps 5 and 6 above. Removal of the sash is accomplished by reversing the installation procedure.

Pivot bar hole 224 in face 222 of carrier body 200 is sized to allow the rotation of pivot bar 600, while preventing wings 604 from moving axially through pivot bar hole 224, to provide the desired “tie in” behavior.

The radius R of arcuate path “A” is indicative of the widest sash which can be installed in this manner, and is defined by the horizontal distance P that head 602 of second pivot bar 600 extends under an overhanging obstruction, commonly the bottom end 14 of channel 12 of block and tackle counterbalance 10, and is further defined by the vertical distance D from the centerline of cam 300 of the second carrier assembly 100 to the overhanging obstruction.

As can be appreciated by inspection of FIG. 18, the radius R of arcuate path “A”, which is indicative of the widest sash that can be installed with the above described method, can be maximized by decreasing the overhang distance P, while increasing the vertical distance D.

To decrease the overhang distance P, one could employ a counterbalance of lesser size, however this option is generally unacceptable, as counterbalances of lesser size typically have reduced weight carrying capacities. Current art and commercially available carriers either fit within the confines of a jamb pocket, or provide for drop in capability by extending substantially through slot 712 of jamb extrusion 700, with attendant loss of sash width capacity. A suitable and significant reduction in overhang distance P is realized with carrier body 200 of carrier assembly 100, by extending face 222 a distance O beyond front wall 708 of jamb extrusion 700, but not beyond sash face 714 so as to not to force a reduction of sash width.

Dimension D, at first appearance could be made as large as needed to achieve any desired radius R for path “A”, however at least two factors limit the expansion of dimension D. A first factor is that in a practical window, the overall length of carrier assembly 100 and counterbalance 10 cannot exceed the height of the sash for which it is used, if the upward travel range of the sash is not to be restricted by the counterbalance system. Secondly, the length of the counterbalance 10 is indicative of the maximum distance it can be extended while still providing an appropriate counterbalancing force. With current commercially available double hung windows, a maximum practical travel distance for any sash is 1.5 inches less than the overall height of the sash. With current commercially available block and tackle counterbalances, the maximum practical travel distance is approximately 2 inches greater than the length of the counterbalance. Combining these two factors mathematically, the overall length of carrier assembly 100 extending beyond channel end 14 of block and tackle counterbalance 10 cannot exceed 3.5 inches, somewhat less, if space is needed at the upper end of counterbalance 10, to effect its mounting within jamb pocket 702.

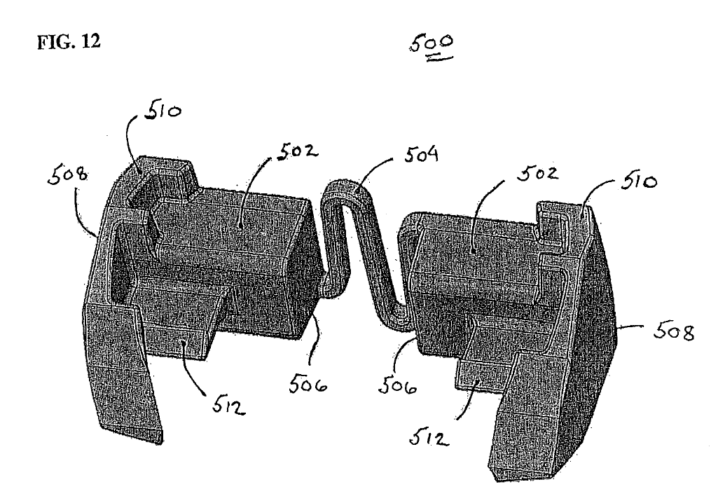

The carrier body 200 depicted in FIGS. 1-18 has been sized to extend approximately 2.5 inches beyond channel 12, to which it is affixed, and 0.060 inches beyond front wall 708 of jamb extrusion 700, and as a result, enables the loading of sash up to approximately 25 inches in width, by the above simplified installation procedure. In the above simplified installation procedure, if the first carrier assembly 100 is positioned at an elevation up to approximately 1 inch lower than the second carrier assembly 100, sash significantly wider than 25 inches can still be loaded. When tilting a sash installed to carrier assemblies positioned at unequal elevations, the sash will not properly align with sash faces 714 of jamb extrusion 700, however, at some point before the sash is tilted to its full vertical position, the carrier assemblies 100 will unlock, and allow the sash to be easily aligned to sash faces 714.

While the inventions has been described with reference to certain features and structure, various modifications may be made without departing from the principle and scope of this invention. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

### PARTS LIST

10 Block and tackle counterbalance
12 Channel
14 Channel end
100 Carrier assembly
200 Carrier body
202 Cam pocket
204 Cam pocket wall
206 Cam pocket end
208 Cam snap
210 Cam snap tip
212 Transverse slot
214 Snap slot
216 Access slot
218 Wider portion
220 Narrower portion
222 Face
224 Pivot bar hole
226 Access slot top
300 Cam
302 Cylindrical front portion
304 Cylindrical surface
306 Front face
308 Cam slot
310 Annular ledge
312 Cam portion
314 Cam surface
316 Back face
400, 500 Lock element
402, 502 Ear portion
404, 504 Serpentine spring
406, 506 Follower surface
408, 508 Brake surface
510 Lock extension
412, 512 Lock snaps
600 Pivot bar
602 Head
604 Wing
700 Jamb extrusion
702 Jamb pocket
704 Back wall
706 Side wall
708 Front wall
710 Return leg
712 Slot
714 Sash face

1. A window balance, comprising:
a) a balance channel for placement in a jamb pocket on a side of a window frame;
b) a carrier located at a lower end of said balance channel, said carrier having a head and an extended section, the extended section being intermediate said head and the lower end of the balance channel; and
c) wherein said extended section has a longitudinal slot allowing placement of a sash pin of a sash positioned in said frame in a cam slot of a cam in said head when an other sash pin of said sash is in an other carrier head located in a position substantially opposed to the head of the carrier having an extended section in an other jamb pocket on an other side of said sash and frame.

2. A window balance as described in claim 1, wherein said head is sized to snugly fit said jamb pocket, said head having a cam operating replaceable locking elements, said locking elements bearing against sides of said jamb pocket when said cam is rotated; and wherein said locking elements are replaceable by other locking elements, which other locking elements allow the head section to snugly fit a larger jamb pocket, said other locking elements bearing against sides of said larger jamb pocket when said cam is rotated.

3. A window balance as described in claim 1, wherein said head has a sash facing side adapted for placement adjacent a sash in said window frame and a frame facing side adapted for placement adjacent said window frame; wherein said cam is insertable into said head from the frame facing side; and wherein a cam retainer holds said cam in position after it has been inserted into said head.

4. A window balance as described in claim 2, wherein said head has a sash facing side adapted for placement adjacent a sash in said window frame and a frame facing side adapted for placement adjacent said window frame; wherein said cam is insertable into said head from the frame facing side; and wherein a cam retainer holds said cam in position after it has been inserted into said head.

5. A window balance, comprising:
a) a balance channel for placement in a jamb pocket of a window frame;
b) a carrier located at a lower end of said balance channel, said carrier having a head sized to snugly fit said jamb pocket, said head having a cam operating replaceable locking elements, said locking elements bearing against sides of said jamb pocket when said cam is rotated; and
c) wherein said locking elements are replaceable by other locking elements, which other locking elements allow the head section to snugly fit a larger jamb pocket, said other locking elements bearing against sides of said larger jamb pocket when said cam is rotated.

6. A window balance as described in claim 5, wherein said head has a sash facing side adapted for placement adjacent a sash in said window frame and a frame facing side adapted for placement adjacent said window frame; wherein said cam is insertable into said head from the frame facing side; and wherein a cam retainer holds said cam in position after it has been inserted into said head.

7. A window balance, comprising:
a) a balance channel for placement in a jamb pocket on a side of a window frame;
b) a carrier located at a lower end of said balance channel, said carrier having a head with a sash facing side adapted for placement adjacent a sash in said window frame and a frame facing side adapted for placement adjacent said window frame;
c) a rotatable cam operating locking elements located in said head, said cam having a slot for a sash pin of a sash and being insertable into said head from the frame facing side; and
c) a cam retainer for holding said cam in position after it has been inserted into said head.

8. A window balance as described in claim 3, wherein said cam retainer is a resilient snap.

9. A window balance as described in claim 4, wherein said cam retainer is a resilient snap.

10. A window balance as described in claim 5, wherein said cam retainer is a resilient snap.

11. A window balance as described in claim 6, wherein said cam retainer is a resilient snap.

12. A window balance as described in claim 1, wherein said head is a “T” shaped head.

13. A window balance as described in claim 2, wherein said head is a “T” shaped head.

14. A window balance as described in claim 3, wherein said head is a “T” shaped head.

15. A window balance as described in claim 4, wherein said head is a “T” shaped head.

16. A window balance as described in claim 5, wherein said head is a “T” shaped head.

17. A window balance as described in claim 6, wherein said head is a “T” shaped head.

18. A window balance as described in claim 7, wherein said head is a “T” shaped head.

19. A window balance as described in claim 8, wherein said head is a “T” shaped head.

20. A window balance as described in claim 9, wherein said head is a “T” shaped head.

21. A window balance as described in claim 10, wherein said head is a “T” shaped head.

22. A window balance as described in claim 11, wherein said head is a “T” shaped head.

23. A window balance as described in claim 1, further comprising a sash pin having an interference feature that interferes with at least one element of said carrier to prevent axial withdrawal of said pin from the carrier.

24. A window balance as described in claim 2, further comprising a sash pin having an interference feature that interferes with at least one element of said carrier to prevent axial withdrawal of said pin from the carrier.

25. A window balance as described in claim 3, further comprising a sash pin having an interference feature that interferes with at least one element of said carrier to prevent axial withdrawal of said pin from the carrier.

26. A window balance as described in claim 4, further comprising a sash pin having an interference feature that interferes with at least one element of said carrier to prevent axial withdrawal of said pin from the carrier.

27. A window balance as described in claim 5, further comprising a sash pin having an interference feature that interferes with at least one element of said carrier to prevent axial withdrawal of said pin from the carrier.

28. A window balance as described in claim 6, further comprising a sash pin having an interference feature that interferes with at least one element of said carrier to prevent axial withdrawal of said pin from the carrier.

29. A window balance as described in claim 7, further comprising a sash pin having an interference feature that interferes with at least one element of said carrier to prevent axial withdrawal of said pin from the carrier.

30. A window balance as described in claim 8, further comprising a sash pin having an interference feature that interferes with at least one element of said carrier to prevent axial withdrawal of said pin from the carrier.

31. A window balance as described in claim 9, further comprising a sash pin having an interference feature that interferes with at least one element of said carrier to prevent axial withdrawal of said pin from the carrier.

32. A window balance as described in claim 10, further comprising a sash pin having an interference feature that interferes with at least one element of said carrier to prevent axial withdrawal of said pin from the carrier.

33. A window balance as described in claim 11, further comprising a sash pin having an interference feature that interferes with at least one element of said carrier to prevent axial withdrawal of said pin from the carrier.

34. A window balance as described in claim 12, further comprising a sash pin having an interference feature that interferes with at least one element of said carrier to prevent axial withdrawal of said pin from the carrier.

35. A window balance as described in claim 13, further comprising a sash pin having an interference feature that interferes with at least one element of said carrier to prevent axial withdrawal of said pin from the carrier.

36. A window balance as described in claim 14, further comprising a sash pin having an interference feature that interferes with at least one element of said carrier to prevent axial withdrawal of said pin from the carrier.

37. A window balance as described in claim 15, further comprising a sash pin having an interference feature that interferes with at least one element of said carrier to prevent axial withdrawal of said pin from the carrier.

38. A window balance as described in claim 16, further comprising a sash pin having an interference feature that interferes with at least one element of said carrier to prevent axial withdrawal of said pin from the carrier.

39. A window balance as described in claim 17, further comprising a sash pin having an interference feature that interferes with at least one element of said carrier to prevent axial withdrawal of said pin from the carrier.

40. A window balance as described in claim 18, further comprising a sash pin having an interference feature that interferes with at least one element of said carrier to prevent axial withdrawal of said pin from the carrier.

41. A window balance as described in claim 19, further comprising a sash pin having an interference feature that interferes with at least one element of said carrier to prevent axial withdrawal of said pin from the carrier.

42. A window balance as described in claim 20, further comprising a sash pin having an interference feature that interferes with at least one element of said carrier to prevent axial withdrawal of said pin from the carrier.

43. A window balance as described in claim 21, further comprising a sash pin having an interference feature that interferes with at least one element of said carrier to prevent axial withdrawal of said pin from the carrier.

44. A window balance as described in claim 22, further comprising a sash pin having an interference feature that interferes with at least one element of said carrier to prevent axial withdrawal of said pin from the carrier.
